(19) United States
(12) Patent Application Publication
(10) Pub. No.: US 2020/0197868 A1
(43) Pub. Date: Jun. 25, 2020

(54) POROUS MEMBRANE AND METHOD FOR PRODUCING POROUS MEMBRANE

(71) Applicant: FUJI XEROX CO., LTD., Tokyo (JP)

(72) Inventors: Daisuke TANO, Kanagawa (JP); Takeshi IWANAGA, Kanagawa (JP); Keiko MATSUKI, Kanagawa (JP)

(73) Assignee: FUJI XEROX CO., LTD., Tokyo (JP)

(21) Appl. No.: 16/390,096

(22) Filed: Apr. 22, 2019

(30) Foreign Application Priority Data
Dec. 21, 2018 (JP) 2018-240148

(51) Int. Cl. B01D 63/06; B01D 67/00; B01D 71/02; B01D 61/24; C02F 1/44

(52) U.S. Cl. CPC B01D 63/063; B01D 63/061; B01D 67/0072; B01D 2323/42; B01D 61/243; C02F 1/44; B01D 71/024

(57) ABSTRACT

A porous membrane includes a porous membrane base containing a polymer compound and having pores interconnected in a thickness direction, and a metal oxide film on inner wall surfaces of the pores.

### CROSS-REFERENCE TO RELATED APPLICATIONS

This application is based on and claims priority under 35 USC 119 from Japanese Patent Application No. 2018-240148 filed Dec. 21, 2018.

### BACKGROUND

### (i) Technical Field

The present disclosure relates to a porous membrane and a method for producing a porous membrane.

### (ii) Related Art

There are known porous membranes, such as water treatment membranes and dialysis membranes, that contain a polymer compound and have inner pores connected in the thickness direction.

For example, Japanese Patent Application Laid-Open No. 2016-69562 discloses a “porous film including a film substrate containing a hydrophobic polymer and having pores open to one surface, and a diamond-like carbon layer formed on the one surface.”

### SUMMARY

The porous membrane as described above tends to have low mechanical strength due to the presence of inner pores.

Under the present circumstances, however, there is a need for porous membranes to have high mechanical strength, such as resistance to breakage, in consideration of application of porous membranes in various fields.

Aspects of non-limiting embodiments of the present disclosure relate to a porous membrane having a higher tensile strength at break than a porous membrane having no metal oxide film on the inner wall surfaces of pores.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a porous membrane including a porous membrane base containing a polymer compound and having pores interconnected in a thickness direction, and a metal oxide film on inner wall surfaces of the pores.

### BRIEF DESCRIPTION OF THE DRAWINGS

Exemplary embodiments of the present disclosure will be described in detail based on the following figures, wherein:

FIG. 1 is a schematic horizontal sectional view of a thin-film forming apparatus 101, which may be used in a method for producing a porous membrane according to an exemplary embodiment; and

FIG. 2 is a schematic sectional side view of the thin-film forming apparatus 101, which may be used in the method for producing a porous membrane according to the exemplary embodiment.

### DETAILED DESCRIPTION

Exemplary embodiments of the present disclosure will be described below.

The units “part by mass” and “% by mass” are synonymous with the units “part by weight” and “% by weight”, respectively.

### Porous Membrane

A porous membrane according to an exemplary embodiment includes a porous membrane base containing a polymer compound and having pores interconnected in a thickness direction, and a metal oxide film on inner wall surfaces of the pores.

An object of a porous membrane including a porous membrane base containing a polymer compound and having pores interconnected in a thickness direction is to filter a liquid, like a water treatment membrane or a dialysis membrane. To inhibit or prevent clogging over time, the inside of the pores may be washed with a pressured washing liquid.

There is thus a need for a porous membrane to have high mechanical strength, such as resistance to breakage.

The porous membrane according to the exemplary embodiment has a metal oxide film formed on the inner wall surfaces of the pores. The presence of the metal oxide film on the inner wall surfaces of the pores may improve the resistance to breakage of the entire porous membrane and may increase the tensile strength at break.

### Polymer Compound

The porous membrane base in the porous membrane according to the exemplary embodiment contains a polymer compound.

The polymer compound is any polymer compound that may form a porous membrane base having pores interconnected in the thickness direction.

Specific examples of the polymer compound include polyolefins, such as polyethylene and polypropylene; fluorine-containing resins, such as polyvinylidene fluoride and polytetrafluoroethylene; fluorine-containing rubbers, such as a vinylidene fluoride-hexafluoropropylene-tetrafluoroethylene copolymer and an ethylene-tetrafluoroethylene copolymer; rubbers, such as a styrene-butadiene copolymer and a hydride thereof, an acrylonitrile-butadiene copolymer and a hydride thereof, an acrylonitrile-butadiene-styrene copolymer and a hydride thereof, a methacrylic acid ester-acrylic acid ester copolymer, a styrene-acrylic acid ester copolymer, an acrylonitrile-acrylic acid ester copolymer, an ethylene propylene rubber, polyvinyl alcohol, and polyvinyl acetate; cellulose derivatives, such as ethyl cellulose, methyl cellulose, hydroxyethyl cellulose, and carboxymethyl cellulose; resins having a melting point and/or glass transition temperature of 180° C. or higher, such as polyphenylene ether, polysulfone, polyether sulfone, polyphenylene sulfide, polyetherimide, polyamideimide, polyimide, polyamide, and polyester.

Among the polymer compounds described above, polyvinylidene fluoride, polyimide, polyether sulfone, polysulfone, and cellulose acetate, which generally have high strength and thermal resistance and chemical resistance, are preferred.

Since the porous membrane according to the exemplary embodiment has the metal oxide film on the inner wall surfaces of the pores and the metal oxide film has chemical resistance against, for example, organic solvents and chemicals, as described above, the polymer compound may be a polymer compound having low chemical resistance.

Examples of the polymer compound having low chemical resistance include those having high strength, such as polystyrene, nylon, polyvinyl chloride, and phenolic resins.

As needed, the porous membrane base of the porous membrane according to the exemplary embodiment may contain, in addition to the polymer compound, a known additive used for porous membranes, such as a chlorine-containing oxidant, such as hypochlorous acid, a hypochlorite (e.g., sodium hypochlorite or calcium hypochlorite), or chlorine dioxide, which is used as an oxidant for causing deposition of metal ions.

The thickness of the porous membrane according to the exemplary embodiment is set according to the application of the porous membrane. For example, the mean thickness is preferably 50 μm or more and 500 μm or less, and more preferably 50 μm or more and 100 μm or less.

The method for measuring the thickness of the porous membrane will be described below.

### Pores Interconnected in Thickness Direction

The porous membrane base of the porous membrane according to the exemplary embodiment has pores (also referred to as interconnected pores) interconnected in the thickness direction. The interconnected pores of the porous membrane base are interconnected from one surface of the porous membrane base to the other surface. In other words, the interconnected pores have both an opening on one surface of the porous membrane base and an opening on the other surface.

The size of the pores is set according to the application of the porous membrane. For example, the size of the pores is in the range of 0.1 μm or more and 50 μm or more, and preferably in the range of 0.5 μm or more and 10 μm or less.

The method for measuring the size of the pores will be described below.

The porous membrane base may have pore size distribution in the thickness direction. In other words, the size of pores in the porous membrane base of the porous membrane according to the exemplary embodiment may gradually increase (or decrease) in the thickness direction of the porous membrane.

The porous membrane base having pore size distribution may have high mechanical strength because such a porous membrane base is easily clogged, which may increase the frequency of washing and the pressure applied to a liquid used for washing. Since the presence of the metal oxide film improves the mechanical strength (e.g., tensile strength at break) of the porous membrane according to the exemplary embodiment, the porous membrane base having pore size distribution as described above may have the metal oxide film.

In such a porous membrane base having pore size distribution in the thickness direction, the mean size of openings on one surface of the porous membrane base differs from the mean size of openings on the other surface. Such a difference in pore size can be confirmed on the basis of the UHR-FE-SEM image of the cross-section of the porous membrane, as described below.

The proportion of the pores in the porous membrane base may be set according to, for example, the strength required for the porous membrane depending on the intended usage of the porous membrane. For example, the proportion of the pores in the porous membrane base is in the range from 20% to 90%, and preferably in the range from 30% to 70%.

The method for measuring the proportion of the pores in the porous membrane base will be described below.

### Metal Oxide Film

The porous membrane according to the exemplary embodiment has the metal oxide film on the inner wall surfaces of the pores. The metal oxide film is a film containing a metal oxide.

The metal oxide may be a metal oxide containing a group 13 element and oxygen (i.e., an oxide of a group 13 element).

Examples of the metal oxide containing a group 13 element and oxygen include metal oxides, such as gallium oxide, aluminum oxide, indium oxide, and boron oxide, and mixed crystals thereof. Among these, gallium oxide is preferred.

The metal oxide film may contain, as needed, other element (e.g., H, Zn, C, Si, Ge, Sn, N, Be, Mg, Ca, or Sr). Among these, H (hydrogen) is preferably contained in the metal oxide film.

The metal oxide film is preferably a film containing gallium oxide as a metal oxide, as described above. The metal oxide film may contain other metal compound as needed.

Examples of other metal compound include silicon oxide, zinc disulfide, aluminum oxide, indium oxide, tin oxide, indium tin oxide (ITO), aluminum-added zinc oxide (AZO), zinc-tin composite oxide (ZTO), aluminum nitride, and silicon carbide.

The metal oxide film preferably contains a group 13 element (more preferably, gallium), oxygen, and hydrogen. The total element composition ratio of the group 13 element, oxygen, and hydrogen relative to all elements in the metal oxide film is preferably 90 atom % or more and more preferably 95 atom % or more.

The elements in the metal oxide film, the element composition ratio, and the like are determined by Rutherford backscattering spectrometry (hereinafter referred to as “RBS”).

In the RBS, 3SDH Pelletron available from NEC Corporation is used as an accelerator, RBS-400 available from CE&A as an end station, and 3S-R10 as a system. For example, the HYPRA program available from CE&A is used for analysis.

The RBS measurement conditions include a He++ ion beam energy of 2.275 eV, a detection angle of 160°, and a grazing angle of 109° with respect to the incident beam.

Specifically, the RBS measurement is performed as described below.

First, a He++ ion beam vertically strikes a sample. The detector is set at 160° with respect to the ion beam, and the backscattered He signal is measured. The composition ratio and the film thickness are determined from the energy and intensity of the detected He. To improve the precision for determining the composition ratio and the film thickness, the spectrum may be measured at two detection angles. The precision is improved by cross-checking the spectrum through the measurement at two detection angles at which the depth-direction resolution and the backscattering dynamics are different.

The number of He atoms backscattered by a target atom is determined by only three factors: 1) the atomic number of the target atom, 2) the energy of He atoms before scattering, and 3) the scattering angle.

The density is assumed by calculation from the measured composition, and the thickness is calculated using the density. An error of the density is within 20%.

The element composition ratio of hydrogen is determined by hydrogen forward scattering spectroscopy (hereinafter referred to as “HFS”.

In the HFS measurement, 3SDH Pelletron available from NEC Corporation is used as an accelerator, RBS-400 available from CE&A as an end station, and 3S-R10 as a system. The HYPRA program available from CE&A is used for analysis. The HFS measurement conditions are as described below.

He++ ion beam energy: 2.275 eV

Detection angle: 160°, Grazing angle: 30° with respect to the incident beam.

In the HFS measurement, the detector is set at 30° with respect to the He++ ion beam, and the sample is set at 75° with respect to the normal line to pick up signals of hydrogen scattered forward of the sample. At this time, the detector may be covered with aluminum foil to remove He atoms scattered together with hydrogen. Quantitative determination is carried out by normalizing the hydrogen counts of reference samples and a test sample on the basis of the stopping power and then comparing the normalized hydrogen counts. As the reference samples, muscovite and a sample obtained by implanting H ions into Si are used.

Muscovite is known to have a hydrogen concentration of 6.5 atom %.

The amount of H adsorbed to the outermost surface is corrected by subtracting, for example, the amount of H adsorbed to a clean Si surface.

The mean thickness of the metal oxide film may be set on the basis of, for example, the strength required for the porous membrane and the size of the pores. The mean thickness of the metal oxide film is, for example, in the range of 0.01 μm or more and 0.2 μm or less.

As the thickness of the metal oxide film increases, the strength (e.g., tensile strength at break) of the porous membrane tends to increase. As the thickness of the metal oxide film increases, the elongation (e.g., tensile elongation at break) of the porous membrane tends to decrease.

For example, when the size of the pores is in the range of 0.5 μm or more and 10 μm or less, the mean thickness of the metal oxide film is preferably 0.02 μm or more and 0.2 μm or less, and more preferably 0.05 μm or more and 0.15 μm or less.

To improve the strength uniformity in the membrane, the degree of thickness uniformity obtained from the following formula (1) may be 20% or less, where X represents the maximum thickness of the metal oxide film and Y represents the minimum thickness of the metal oxide film. A smaller degree of thickness uniformity is more preferred. The degree of thickness uniformity is more preferably 10% or less. The metal oxide film in the porous membrane preferably has higher thickness uniformity.

Degree of thickness uniformity=(X−Y)/(X+Y)×100 Formula (1):

The method for measuring the thickness of the metal oxide film will be described below.

The metal oxide film can improve the tensile strength at break as long as the metal oxide film is formed along part of the inner wall surfaces of the pores. To improve the strength uniformity in the membrane and facilitate production, the metal oxide film is preferably formed in the largest possible area of the inner wall surfaces of the pores.

The metal oxide film may be formed along the exposed surfaces (including one surface and the other surface of the porous membrane base) other than the surfaces of the pores of the porous membrane base.

### Measurement Method

The thickness of the porous membrane, the size of the pores, the proportion of the pores, and the thickness of the metal oxide film are measured through observation with a scanning electron microscope.

First, the porous membrane is cut in the thickness direction by the freeze-fracture technique to provide a sample for cross-sectional observation. The sample is thinly coated with platinum to provide a test sample. Next, the cross-section of the test sample is observed with a high-resolution field emission scanning electron microscope (UHR-FE-SEM) at an acceleration voltage of 3 kV or more and 6 kV or less. The high-resolution field emission scanning electron microscope is, for example, a S-900 electron microscope available from Hitachi, Ltd.

From the obtained UHR-FE-SEM image, the thickness of the porous membrane, the size of the pores, the proportion of the pores, and the thickness of the metal oxide film are measured.

The methods for measuring these characteristics will be described below in detail.

### Thickness of Porous Membrane

The thickness of the test sample is measured at freely selected ten points in the UHR-FE-SEM image, and the mean of the thicknesses is taken as the thickness (mean thickness) of the porous membrane.

### Size of Pores

The UHR-FE-SEM image is obtained at a magnification adjusted so as to observe plural pores (e.g., 50 pores or more and 200 pores or less) in one field of view in the above-described observation.

Since the pores are interconnected, the maximum diameter of the pores in the SEM image is calculated with analysis software and taken as a size.

The sizes of 50 pores are measured, and the mean thereof is taken as the size (mean size) of the pores.

### Proportion of Pores

The same UHR-FE-SEM image as that for measuring the size of the pores is obtained.

In this UHR-FE-SEM image, the proportion of the area of the pore portion (i.e., void portion) in the area of the porous membrane base containing pores is measured.

The obtained proportion of the area of the pore portion is taken as the proportion of the pores.

### Thickness of Metal Oxide Film

The same UHR-FE-SEM image as that for measuring the size of the pores is obtained.

The thickness of the metal oxide film present on the inner wall surfaces of the pores is measured at freely selected 50 points in the UHR-FE-SEM image. At this time, the thickness of the metal oxide film is measured at 5 points or more and 10 points or less for each pore.

The maximum value, the minimum value, and the mean of the obtained thicknesses of the metal oxide film at 50 points are the maximum thickness (X), the minimum thickness (Y), and the mean thickness, respectively.

### Physical Properties

### Tensile Strength at Break

The tensile strength at break of the porous membrane according to the exemplary embodiment is preferably 5 MPa or more (more preferably 7 MPa or more, and still more preferably 10 MPa or more).

The tensile strength at break can be adjusted by, for example, the strength of the polymer compound in the porous membrane base of the porous membrane, the area of regions of the inner wall surfaces of the pores in which the metal oxide film is formed, and the thickness of the metal oxide film. In particular, the thickness of the metal oxide film greatly affects the tensile strength at break. As the thickness of the metal oxide film increases, the tensile strength at break tends to increase.

### Tensile Elongation at Break

The tensile elongation at break of the porous membrane according to the exemplary embodiment is preferably 50% or more (more preferably 80% or more, and still more preferably 100% or more).

The tensile elongation at break can be adjusted by, for example, the elongation of the polymer compound in the porous membrane base of the porous membrane, the area of regions of the inner wall surfaces of the pores in which the metal oxide film is formed, and the thickness of the metal oxide film. In particular, the thickness of the metal oxide film greatly affects the tensile elongation at break. As the thickness of the metal oxide film increases, the tensile elongation at break tends to decrease.

The tensile elongation at break and the tensile strength at break of the porous membrane are measured as described below.

First, a strip-shaped test sample 5 mm wide, 100 mm long, and 100 μm thick is prepared.

The strip-shaped test sample is stretched with Strograph VE-1D (available from Toyo Seiki Co., Ltd.) under the following conditions. The tensile strength at break is calculated from the stress (load/cross-sectional area) at break of the test sample, and the tensile elongation at break is calculated from the displacement at break of the test sample.

Chuck distance: 50 mm

Tensile speed: 500 mm/min

Temperature: 23° C.

Relative humidity: 55%

### Permeation Flux

The permeation flux of water pressurized at a pressure of 20 kPa through the porous membrane according to the exemplary embodiment is preferably 0.2 L/(m²·h) or more (more preferably 0.3 L/(m²·h) or more).

The permeation flux is an indication of liquid permeation performance.

Specifically, deionized water is caused to permeate the porous membrane under an operating pressure of 20 kPa (≈0.2 kgf/cm², and the amount of deionized water that permeates per unit time and per unit membrane area is measured and taken as “permeation flux”. The unit is L/(m²·h).

The permeation flux tends to be affected by the strength (e.g., tensile strength at break) and the elongation (e.g., tensile elongation at break) of the porous membrane. To improve permeation flux, the strength (e.g., tensile strength at break) and the elongation (e.g., tensile elongation at break) of the porous membrane may be well-balanced by controlling the thickness of the metal oxide film.

### Application

Since the porous membrane according to the exemplary embodiment has high tensile strength at break, the porous membrane may be used in applications where at least one of liquid and gas passes through interconnected pores.

Specifically, the porous membrane according to the exemplary embodiment may be used as a type of filter, a water treatment membrane (a membrane through which impurities that cannot pass through interconnected pores are removed from water), a dialysis membrane, a separator in the field of battery, a heat-insulating film, a low-k film (i.e., low-dielectric constant film) in an electronic component substrate.

In particular, since the presence of the metal oxide film causes the inner wall surfaces of the pores to have chemical resistance, the porous membrane according to the exemplary embodiment may be used in applications (e.g., used as the water treatment membrane and the dialysis membrane described above) where washing with chemicals is performed to remove clogging of organic matter.

### Method for Producing Porous Membrane

The porous membrane according to the exemplary embodiment is produced as follows: first, preparing a porous membrane base (hereinafter also referred to as a metal oxide film formation object) containing a polymer compound and having pores interconnected in the thickness direction; and forming a metal oxide film on the inner wall surfaces of the pores of the obtained porous membrane base.

The method for producing the porous membrane including the porous membrane base (i.e., metal oxide film formation object) containing a polymer compound and having pores interconnected in the thickness direction is not necessarily but preferably the following method using resin particles because it is easy to control, for example, the size of pores and the proportion of pores.

First, a coating liquid is prepared by dissolving a polymer compound (e.g., polyimide, polyvinylidene fluoride, polysulfone, polyether sulfone) in a solvent to provide a solution and adding, to the solution, resin particles that are not dissolved in the solution. By using the prepared coating liquid, a coating film is formed so as to have an intended thickness and then dried by heating to form a film. The resin particles in the film are then removed by dissolving them with an organic solvent to provide a metal oxide film formation object.

The size of the pores is controlled by the adjustment of the size of the resin particles, and the proportion of the pores is controlled by the adjustment of the amount of the resin particles added.

Examples of other methods for producing the metal oxide film formation object include a metal powder sintering method, a sol-gel method, and a phase-separation elution method.

The method for forming the metal oxide film on the inner wall surfaces of the pores of the porous membrane base (i.e., metal oxide film formation object) is not necessarily but preferably a plasma CVD method.

Specifically, the metal oxide film may be formed on the inner wall surfaces of the pores of the metal oxide film formation object by using the following method (i.e., a method for producing a porous membrane according to an exemplary embodiment).

The method for producing a porous membrane according to the exemplary embodiment is a method for producing a porous membrane having a metal oxide film on the inner wall surfaces of pores. The method includes:

supplying a film forming gas to a reaction inactive region of a reactor that includes, in an inside thereof, a porous membrane including a porous membrane base (i.e., metal oxide film formation object) containing a polymer compound and having pores interconnected in a thickness direction, is designed to use excitation and decomposition of the film forming gas supplied to the inside so as to deposit a film having an element of the film forming gas as a constituent element, and has a reaction active region where the film-forming gas is capable of being excited and decomposed and the reaction inactive region continuous with the reaction active region;

exciting and decomposing the film forming gas in the reactor;

repeatedly moving the porous membrane between the reaction inactive region and the reaction active region by driving a holding member while the porous membrane is held by the holding member, wherein the film forming gas is supplied to the reaction active region from the reaction inactive region along with movement of the porous membrane; and

exhausting gas from the reactor through an exhaust pipe in the reactor, the gas having passed through the pores of the porous membrane base of the porous membrane held by the holding member.

The method for producing a porous membrane according to the exemplary embodiment will be described below by using the drawings and with reference to a thin-film forming apparatus that may be used in the method for producing a porous membrane.

It is noted that members having substantially the same function in the drawings are denoted by the same reference symbols throughout the drawings, and overlapping description thereof may be appropriately omitted.

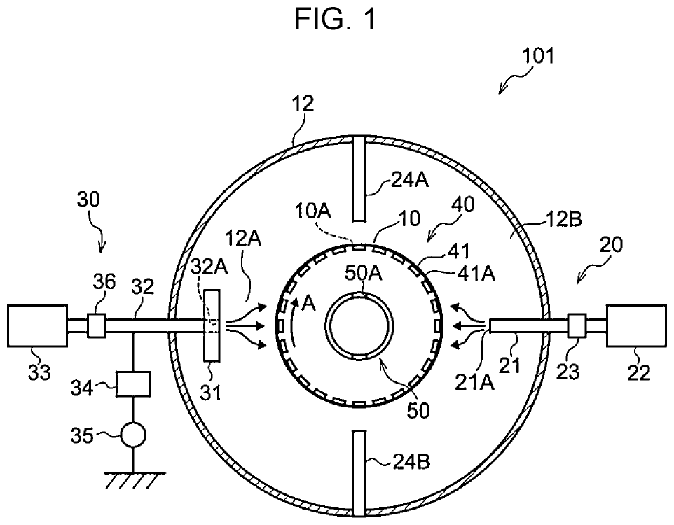

FIG. 1 is a schematic horizontal sectional view of a thin-film forming apparatus 101, which may be used in the method for producing a porous membrane according to the exemplary embodiment.

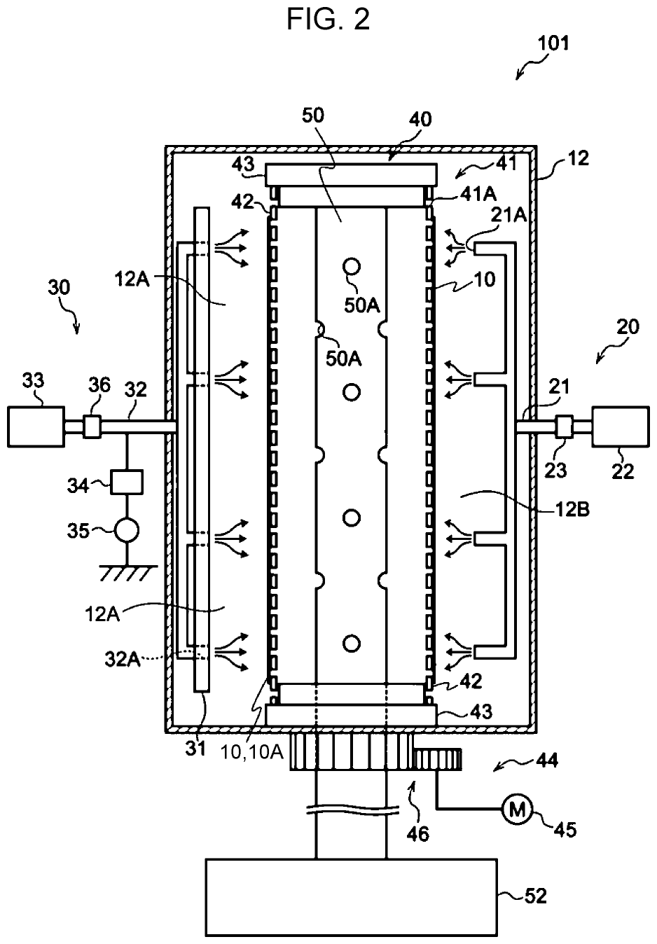

FIG. 2 is a schematic sectional side view of the thin-film forming apparatus 101, which may be used in the method for producing a porous membrane according to the exemplary embodiment.

As illustrated in FIG. 1 and FIG. 2, the thin-film forming apparatus 101 forms, on a metal oxide film formation object 10, a film having an element of the film forming gas as a constituent element by using excitation and decomposition of the film forming gas.

Specifically, for example, as illustrated in FIG. 1 and FIG. 2, the thin-film forming apparatus 101 includes a reactor 12; a film-forming-gas supply device 20, which supplies a film forming gas into the reactor 12; an excitation device 30, which excites and decomposes the film forming gas in the reactor 12; a holding device 40, which holds the metal oxide film formation object 10; and an exhaust pipe 50, through which the gas is exhausted from the reactor 12.

The thin-film forming apparatus 101 further includes an evacuation device 52, which evacuates gas from the reactor 12 through the exhaust pipe 50.

A thin film formed by the thin-film forming apparatus 101 is at least a metal oxide film grown on the inner wall surfaces of the pores (i.e., openings 10A) of the metal oxide film formation object 10.

The metal oxide film may have a crystalline structure, such as a single-crystalline structure or a polycrystalline structure, or an amorphous structure. The metal oxide film may have a microcrystalline structure in which crystal grains with a crystal grain size from 5 nm to 100 μm are dispersed in the amorphous matrix.

In FIG. 1 and FIG. 2, a thin film is formed not only on the inner wall surfaces of the pores (i.e., openings 10A) of the metal oxide film formation object 10 but also on the surface of the metal oxide film formation object 10 that faces a reaction active region 12A (hereinafter referred to simply as the surface of the metal oxide film formation object 10), and the side surfaces of the metal oxide film formation object 10 (the surfaces that intersect the surface of the metal oxide film formation object 10 facing the reaction active region 12A, hereinafter referred to simply as the side surfaces of the metal oxide film formation object 10).

The metal oxide film formation object 10 is disposed in the reactor 12. More specifically, the metal oxide film formation object 10 is disposed in the reactor 12 while being held by the holding device 40 (a holding member 41 thereof).

The reactor 12 includes, in the inside thereof, the reaction active region 12A, where the film forming gas is capable of being excited and decomposed, and a reaction inactive region 12B, which is continuous with the reaction active region 12A. The reactor 12 contains two shield members 24A and 24B, which shield at least part of the boundaries between the reaction active region 12A and the reaction inactive region 12B.

The reaction active region 12A means a region where the film forming gas is excited and decomposed when the film forming gas reaches the region. In the case of using a non-film-forming gas, the reaction active region 12A also means a region where the non-film-forming gas is excited and decomposed when the non-film-forming gas reaches the region. Specifically, in the exemplary embodiment, the reaction active region 12A means, in addition to a region where the non-film-forming gas is excited and decomposed, a region where the film forming gas is excited and decomposed upon exposure to an excited and decomposed gas (i.e., non-film-forming plasma) of the non-film-forming gas.

The reaction inactive region 12B means a region that is continuous with the reaction active region 12A and in which the film forming gas, although present, is not excited or decomposed.

The holding device 40 includes the holding member 41, which holds the metal oxide film formation object 10; and a drive unit 44, which repeatedly moves the metal oxide film formation object 10 between the reaction inactive region 12B and the reaction active region 12A by driving the holding member 41. The film forming gas is supplied to the reaction active region from the reaction inactive region 12B along with movement of the metal oxide film formation object 10.

The holding member 41 includes, for example, a tubular member. The tubular member has, for example, openings 41A through which gases (e.g., the film forming gas, and the excited and decomposed gas of the non-film-forming gas) in the reactor 12 pass. Specifically, the holding member 41 includes, for example, a tubular section 42, which has openings 41A through which gases (e.g., the film forming gas, and the excited and decomposed gas of the non-film-forming gas) in the reactor 12 pass, and supports 43, which support the opposed ends of the tubular section 42 in the axial direction.

The holding member 41 (the tubular section 42 thereof) is, for example, interposed between the exhaust pipe 50 and film-forming-gas supply ports 21A of the film-forming-gas supply device 20. The holding member 41 is, for example, interposed between the exhaust pipe 50 and the reaction active region 12A.

Specifically, the exhaust pipe 50 is disposed inside the holding member 41 including the tubular member. A shield member 24A, a film-forming-gas supply pipe 21 of the film-forming-gas supply device 20, a shield member 24B, and a discharge electrode 31 of the excitation device 30 are disposed in this order around the outer circumference of the holding member 41 along the rotation direction (the direction denoted by arrow A of the holding member). The reaction active region 12A and the reaction inactive region 12B, which are shielded by the two shield members 24A and 24B, are present around the outer circumference of the holding member 41.

The tubular section 42 of the holding member 41 holds the metal oxide film formation object 10 on the outer surface of the tubular section 42. Specifically, the metal oxide film formation object 10 is, for example, held on the outer surface of the tubular section 42 by means of, for example, a double-sided tape or a fastener.

Examples of the tubular section 42 include a mesh member formed of crossed metal wires, a mesh member formed of crossed metal strips, and a mesh member obtained by processing a metal plate into a mesh form.

The tubular section 42 may have a round tubular shape or a polygonal tubular shape. In FIG. 1 and FIG. 2, the tubular section 42 has a round tubular shape.

The tubular section 42 of the holding member 41 may be a self-supporting (e.g., rigid) member or a flexible member. When the tubular section 42 of the holding member 41 is a flexible member, the supports 43 of the holding member 41 may support the tubular section 42 while being in contact with the inner surface of the tubular section 42 and applying tension to the tubular section 42.

The holding member 41 may be, for example, a belt with ends, or a plate-shaped member.

The drive unit 44 of the holding device 40 includes, for example, a motor 45, which drives the holding member 41, and a drive transmission section 46 (e.g., gear), which is connected to one of the supports 43 of the holding member 41 and transmits a driving force of the motor 45 to the holding member 41.

Specifically, the drive unit 44 transmits, for example, rotation drive of the motor 45 to the holding member 41 via the drive transmission section 46 and rotationally drives the holding member 41 in the direction denoted by arrow A. Accordingly, the drive unit 44 repeatedly moves the metal oxide film formation object 10 between the reaction inactive region 12B and the reaction active region 12A.

The drive unit 44 of the holding device 40 does not necessarily perform rotation drive of the holding member 41 in one direction and may repeatedly perform forward rotation drive and reverse rotation drive of the holding member 41.

When the holding member 41 is, for example, a belt with ends or a plate-shaped member, the drive unit 44 may perform reciprocating drive of the holding member 41.

The film-forming-gas supply device 20 includes the film-forming-gas supply pipe 21 and a film-forming-gas source 22.

The film-forming-gas supply pipe 21 is used to supply a film forming gas to the inside of the reactor 12 from the outside of the reactor 12. The film-forming-gas supply pipe 21 communicates with the inside of the reactor 12 through one or more film-forming-gas supply ports 21A at one end of the film-forming-gas supply pipe 21. The other end of the film-forming-gas supply pipe 21 is connected to the film-forming-gas source 22 via a solenoid valve 23.

The film-forming-gas source 22 includes, for example, a container filled with a film forming gas; a mechanism for controlling the temperature of the film forming gas, such as a thermostatic bath; a mechanism for controlling the pressure, such as a regulator; and a mechanism for controlling the flow rate of the film forming gas, such as a mass flow controller, although not illustrated. When the film forming gas is a gas generated by vaporizing a liquid or solid, the film forming gas is charged into a thermostatic bath maintained at an intended temperature and, as needed, supplied into the reactor 12 together with a carrier gas. During supply of the carrier gas, the carrier gas is supplied at an intended pressure.

The film forming gas supplied to the film-forming-gas supply pipe 21 from the film-forming-gas source 22 reaches the film-forming-gas supply ports 21A through the film-forming-gas supply pipe 21 and is ejected from the film-forming-gas supply ports 21A into the reactor 12.

The film-forming-gas supply ports 21A are located in the reaction inactive region 12B in the reactor 12 and provided on the film-forming-gas supply pipe 21.

The film-forming-gas supply ports 21A may be located in a region distant from the boundaries between the reaction active region 12A and the reaction inactive region 12B. The “region distant from the boundaries between the reaction active region 12A and the reaction inactive region 12B” is a part of the reaction inactive region 12B where the film forming gas is diffused so as to make the density of the film forming gas uniform, specifically, a region 20 mm or more distant from the boundaries between the reaction active region 12A and the reaction inactive region 12B.

When the film-forming-gas supply ports 21A are located in a region distant from the boundaries between the reaction active region 12A and the reaction inactive region 12B, a thin film having non-uniform thickness and non-uniform quality formed as a result of introduction of the film forming gas with non-uniform density into the reaction active region 12A is unlikely to form.

The direction in which the film forming gas is ejected from the film-forming-gas supply ports 21A may be toward the metal oxide film formation object 10 on which a thin film is to be formed.

Specifically, the direction in which the film forming gas is ejected from the film-forming-gas supply ports 21A may be toward the outer surface of the holding member 41 (the tubular section 42 thereof).

More specifically, the direction in which the film forming gas is ejected from the film-forming-gas supply ports 21A may be a direction in which the film forming gas flows in the reaction inactive region 12B other than toward the reaction active region 12A.

When the film forming gas flows in a direction other than toward the reaction active region 12A, the film forming gas tends to travel in the reactor 12 to reach the reaction active region 12A with the gas density uniform.

The “film forming gas” is a gas that may generate a reaction product by itself after excited and decomposed, or a gas that may generate a reaction product when reacting with an excited and decomposed gas generated by exciting and decomposing a non-film-forming gas.

Specifically, the film forming gas is a gas that deposits, after excited and decomposed, a reaction product having an element of the film forming gas as a constituent element, or a gas that deposits a reaction product having elements of the film forming gas and the non-film-forming gas as constituent elements when reacting with an element of an excited and decomposed non-film-forming gas.

For example, in the case of forming a thin film (i.e., metal oxide film) formed of an oxide of a group 13 element, a compound gas containing a group 13 element is used as a film forming gas.

Specific examples of the film forming gas include trimethylgallium, trimethylindium, trimethylaluminum, triethylgallium, triethylindium, triethylaluminum, t-butylgallium, t-butylgallium, t-butylindium, diborane, boron trifluoride, boron trichloride, and boron tribromide.

The excitation device 30 includes the discharge electrode 31, a non-film-forming-gas supply pipe 32, and a non-film-forming-gas source 33.

The discharge electrode 31 is connected to a high-frequency power source 35, which supplies an electric power to the discharge electrode 31, via a matching box 34. The high-frequency power source 35, which serves as a power supply source, is a direct-current power source or an alternating-current power source. In particular, the high-frequency power source 35 may be, for example, a high-frequency alternating-current power source or a microwave power source in order to efficiently excite gas.

The discharge electrode 31 has a discharge surface that faces the outer surface of the holding member 41 of the holding device 40. The discharge surface of the discharge electrode 31 is spaced apart from the holding member 41. The discharge surface of the discharge electrode 31 is oriented such that at least part of generated plasma comes into contact with the metal oxide film formation object 10 held by the holding member 41.

The case where the discharging method used by the discharge electrode 31 is capacitive discharging will be described below, but the discharge method may be inductive discharging.

The discharge electrode 31 is, for example, a gas-permeable electrode having a hollow structure (cavity structure) and having the discharge surface with plural gas supply holes (not illustrated) for supplying a non-film-forming gas. When a discharge electrode that does not have a cavity structure or gas supply holes on its discharge surface is used as the discharge electrode 31, the non-film-forming-gas supply pipe 32 in the excitation device 30 is located such that the non-film-forming gas supplied from separately provided non-film-forming-gas supply ports 32A passes through a space between the discharge electrode 31 and the holding member 41.

To prevent or reduce electric discharge between the discharge electrode 31 and the reactor 12, the electrode surfaces of the discharge electrode 31 other than the surface that faces the outer surface of the holding member 41 may be covered with an insulating member, with a gap of about 3 mm or less between the electrode surfaces and the insulating member.

The non-film-forming-gas supply pipe 32 is used to supply a non-film-forming gas into the reactor 12. One end of the non-film-forming-gas supply pipe 32 communicates with the inside of the reactor 12 through one or more non-film-forming-gas supply ports 32A, which are opened beforehand in the direction that intersects the discharge surface of the discharge electrode 31. The other end of the non-film-forming-gas supply pipe 32 is connected to the non-film-forming-gas source 33 via a solenoid valve 36.

The non-film-forming-gas source 33 includes, for example, a container filled with a non-film-forming gas; a mechanism for controlling the pressure, such as a regulator; and a mechanism for controlling the flow rate of the film forming gas, such as a mass flow controller. When two or more non-film-forming gases are used, these gases may be combined and supplied.

The non-film-forming gas passes through the non-film-forming-gas supply pipe 32 from the non-film-forming-gas source 33 and is supplied into the reactor 12 from the non-film-forming-gas supply ports 32A.

The “non-film-forming gas” is a gas (i.e., a gas incapable of film formation) that may not generate a reaction product by itself or form a thin film after excited. Therefore, even when the non-film-forming gas alone is supplied to the reaction active region 12A, the non-film-forming gas alone does not generate a reaction product.

Examples of the non-film-forming gas include gases, such as N₂, H₂, NH₃, N₂H₄, O₂, O₃, NO, N₂O, He, Ar, Ne, Kr, and Xe, and mixed gases thereof.

In particular, when an oxide is generated as a reaction product of an excited and decomposed gas generated by exciting and decomposing the film forming gas (when an oxide forms a thin film), for example, an O (oxygen)-containing gas is used as a non-film-forming gas.

The exhaust pipe 50 is used to exhaust gas from the reactor 12 through plural exhaust ports 50A.

The exhaust pipe 50 is, for example, closed at one end. The other end of the exhaust pipe 50 is connected to the evacuation device 52, which evacuates gas from the reactor 12.

The exhaust pipe 50 faces, for example, the film-forming-gas supply ports 21A of the film-forming-gas supply device 20 with the metal oxide film formation object 10, which is held by the holding member 41, interposed therebetween. The exhaust pipe 50 faces, for example, the reaction active region 12A in the reactor 12 with the metal oxide film formation object 10, which is held by the holding member 41, interposed therebetween.

Specifically, the exhaust pipe 50 is, for example, disposed on the inner surface side of the tubular member (the tubular section 42 thereof) serving as the holding member 41 and used to exhaust gases (e.g., the film forming gas, the non-film-forming gas, and the excited and decomposed gases of these gases) supplied into the reactor 12.

The exhaust pipe 50 disposed on the inner surface side of the holding member 41 is used to exhaust the film forming gas and the excited and decomposed gas (i.e., non-film-forming plasma) of the non-film-forming gas, which gases have passed over the wall surfaces of the openings 10A (i.e., over the inner wall surfaces of the pores) of the metal oxide film formation object 10 held by the holding member 41.

Specifically, for example, in the reaction inactive region 12B, the exhaust pipe 50 is used to exhaust the film forming gas that has passed over the wall surfaces of the openings 10A (i.e., over the inner wall surfaces of the pores) of the metal oxide film formation object 10 held by the holding member 41. In the reaction active region 12A, the exhaust pipe 50 is used to exhaust the excited and decomposed gas (i.e., non-film-forming plasma) of the non-film-forming gas, which has passed over the wall surfaces of the openings 10A (i.e., over the inner wall surfaces of the pores) of the metal oxide film formation object 10 held by the holding member 41.

The exhaust pipe 50 may have any structure as long as the gases (e.g., the film forming gas, and the excited and decomposed gas of the non-film-forming gas (e.g., at least the film forming gas when only the film forming gas is supplied into the reactor 12)) in the reactor 12 are exhausted through the exhaust pipe 50 such that the gases flow so as to pass over the wall surfaces of the openings 10A (i.e., over the inner wall surfaces of the pores) of the metal oxide film formation object 10 held by the holding member 41.

The evacuation device 52 reduces the inner pressure of the reactor 12 to an intended pressure. The evacuation device 52 includes, for example, one or more pumps and, as needed, an exhaust rate adjustment mechanism, such as a conductance valve.

The inner pressure of the reactor 12 during film formation determined according to the gas supply amount and the exhaust rate is, for example, 1 Pa or more and 200 Pa or less. The inner pressure of the reactor 12 during film formation is any pressure at which plasma is generated in the reactor 12 and also depends on the type of gas and the type of power source.

The shield members 24A and 24B are disposed in the reactor 12 and shield at least part of the boundaries between the reaction active region 12A and the reaction inactive region 12B. The shield members 24A and 24B are each formed of, for example, a plate-shaped member. One end of each of the shield members 24A and 24B is fixed to the inner wall of the reactor 12. The other end of each of the shield members 24A and 24B faces the outer surface of the holding member 41 (the tubular section 42 thereof) at a distance from each other.

The shield members 24A and 24B shield against the excited and decomposed gas (i.e., non-film-forming plasma) of the non-film-forming gas in the reaction active region 12A to such an extent that the intended reaction product is not generated by excitation and decomposition of the film forming gas when the film forming gas is supplied to the reaction inactive region 12B.

The minimum distance between each of the shield members 24A and 24B and the outer surface of the holding member 41 (the tubular section 42 thereof) is, for example, a distance sufficient to shield part of regions between the reaction inactive region 12B and the reaction active region 12A and to ensure thin film formation on the metal oxide film formation object 10 held by the holding member 41.

Specifically, for example, when the shield members 24A and 24B face the metal oxide film formation object 10, the minimum distance between each of the shield members 24A and 24B and the metal oxide film formation object 10 is preferably 10 mm or more, and more preferably 2 mm or more.

The distance between each of the shield members 24A and 24B and the metal oxide film formation object 10 may be adjusted. To adjust the distance, for example, the shield members 24A and 24B are detachably attached to the reactor 12, and the shield members 24A and 24B each have a size that is scaled according to the size of the metal oxide film formation object 10 and the film thickness of an intended thin film.

The shield members 24A and 24B may be in contact with the holding member 41 (the tubular section 42 thereof) or the metal oxide film formation object 10. Preferably, the shield members 24A and 24B are in contact with the holding member 41 (the tubular section 42 thereof) or the metal oxide film formation object 10 at a contact force that generates no friction therebetween. This is to prevent or reduce generation of scratches on the metal oxide film formation object 10 itself, generation of scratches on a thin film formed on the metal oxide film formation object 10, and scraping of a thin film formed on the metal oxide film formation object 10, which are caused by the shield members 24A and 24B.

The shield members 24A and 24B are made of any material having mechanical strength, and may be formed of a conductive member or an insulating member.

However, when the shield members 24A and 24B are in contact with the holding member 41 (the tubular section 42 thereof) or the metal oxide film formation object 10, the shield members 24A and 24B may be made of a material having lower hardness than the metal oxide film formation object 10 and a film formed on the metal oxide film formation object 10 in order to prevent or reduce scratches on the metal oxide film formation object 10 itself, scratches on the thin film, and release of the thin film.

The shield members 24A and 24B are disposed as needed. However, the apparatus can be miniaturized when the shield members 24A and 24B separate the reaction inactive region 12B from the reaction active region 12A. Therefore, the shield members 24A and 24B are preferably disposed.

Next, the thin film forming method by the thin-film forming apparatus 101 will be described.

First, in the thin-film forming apparatus 101, the metal oxide film formation object 10 is held on the outer surface of the holding member 41 (the tubular section 42 thereof).

Next, the evacuation device 52 is driven to reduce the inner pressure of the reactor 12 to an intended pressure. After the inner pressure of the reactor 12 is reduced, the drive unit 44 rotationally drives the holding member 41 in the holding device 40.

Next, in the excitation device 30, a high-frequency power is supplied to the discharge electrode 31 from the high-frequency power source 35 via the matching box 34. The solenoid valve 36 is then opened so that the non-film-forming gas passes through the non-film-forming-gas supply pipe 32 and the non-film-forming-gas supply ports 32A from the non-film-forming-gas source 33. The non-film-forming gas is thus supplied to a region (i.e., the reaction active region 12A) in the reactor 12 in which the discharge surface of the discharge electrode 31 faces the outer surface of the holding member 41. An excited and decomposed gas (i.e., non-film-forming plasma) of the non-film-forming gas is generated by electric discharge from the discharge surface of the discharge electrode 31.

Meanwhile, the solenoid valve 23 is opened so that the film forming gas is supplied to the reaction inactive region 12B in the reactor 12 through the film-forming-gas supply ports 21A of the film-forming-gas supply pipe 21 from the film-forming-gas source 22.

In the reaction inactive region 12B, the exhaust pressure of the exhaust pipe 50 causes the film forming gas to pass over the wall surfaces of the openings 10A of the metal oxide film formation object 10 held by the holding member 41 and to be exhausted through the exhaust pipe 50. At this time, the film forming gas is adsorbed to the surface, the wall surfaces of the openings 10A, and the side surfaces of the metal oxide film formation object 10 held by the holding member 41.

The film forming gas present around the metal oxide film formation object 10, and the film forming gas adsorbed to the surface, the wall surfaces of the openings 10A, and the side surfaces of the metal oxide film formation object 10, among the film forming gas supplied to the reaction inactive region 12B from the film-forming-gas supply ports 21A, move to the reaction active region 12A along with movement of the metal oxide film formation object 10 caused by rotation drive of the holding member.

The film forming gas that has moved from the reaction inactive region 12B to the reaction active region 12A is then exposed to the excited and decomposed gas (i.e., non-film-forming plasma) of the non-film-forming gas and excited and decomposed in the reaction active region 12A to generate an excited and decomposed gas.

Next, the exhaust pressure of the exhaust pipe 50 causes the excited and decomposed gas of the film forming gas and the excited and decomposed gas of the non-film-forming gas to move onto the surface of the metal oxide film formation object 10 that may face the reaction active region and transfer onto (pass over) the wall surfaces of the openings 10A (i.e., the inner wall surfaces of the pores) and the side surfaces of the metal oxide film formation object 10.

In the reaction active region 12A, the exhaust pressure of the exhaust pipe 50 causes the generated excited and decomposed gas (i.e., non-film-forming plasma) of the non-film-forming gas to pass over the wall surfaces of the openings 10A of the metal oxide film formation object 10 held by the holding member 41 and to be exhausted through the exhaust pipe 50. At this time, the film forming gas present around the metal oxide film formation object 10, and the film forming gas adsorbed to the surface, and the wall surfaces of the openings 10A, and the side surfaces of the metal oxide film formation object 10 are exposed to the excited and decomposed gas (i.e., non-film-forming plasma) of the non-film-forming gas. Accordingly, the film forming gas is excited and decomposed.

This generates a reaction product having an element of the film forming gas as a constituent element and a reaction product having an element of the film forming gas and an element of the non-film-forming gas as constituent elements. The generated reaction product is deposited on the surface of the metal oxide film formation object 10, and the wall surfaces of the openings 10A. As a result, a thin film (i.e., metal oxide film) having an element of the film forming gas as a constituent element, or a thin film (i.e., metal oxide film) having an element of the film forming gas and an element of the non-film-forming gas as constituent elements is formed on the surface of the metal oxide film formation object 10 and the wall surfaces of the openings 10A (i.e., the inner wall surfaces of the pores).

This effect is obtained when the continuous rotation of the holding member 41 causes the metal oxide film formation object 10 to repeatedly move between the reaction active region 12A and the reaction inactive region 12B in the reactor 12. As a result, a reaction product having an element of the film forming gas as a constituent element or having an element of the film forming gas and an element of the non-film-forming gas as constituent elements is gradually deposited on the wall surfaces of the openings 10A of the metal oxide film formation object 10, which leads to formation of a thicker film.

The film forming gas, the non-film-forming gas, and the excited and decomposed gases thereof that are not associated with the reaction and have passed through the openings 10A of the metal oxide film formation object 10 and the holding member 41 (the tubular section 42 thereof) are exhausted through the exhaust pipe 50.

An example of the case where a gallium oxide (α-Ga₂O₃) film is formed as a film will be specifically described below.

In the case of forming a gallium oxide (GaO) film, for example, a mixed gas of hydrogen and oxygen is supplied as a non-film-forming gas to a region (i.e., the reaction active region 12A) in the reactor 12 where the discharge surface of the discharge electrode 31 faces the outer surface of the holding member 41. An excited and decomposed gas (i.e., hydrogen plasma) of hydrogen and an excited and decomposed gas (i.e., oxygen plasma) of oxygen are generated by electric discharge from the discharge surface of the discharge electrode 31.

Meanwhile, trimethylgallium is supplied as a film forming gas to the reaction inactive region 12B in the reactor 12.

In the reaction inactive region 12B, the exhaust pressure of the exhaust pipe 50 causes trimethylgallium to pass over the wall surfaces of the openings 10A of the metal oxide film formation object 10 held by the holding member 41 and to be exhausted through the exhaust pipe 50. At this time, trimethylgallium is adsorbed to the surface, the wall surfaces of the openings 10A, and the side surfaces of the metal oxide film formation object 10 held by the holding member 41.

Trimethylgallium present around the metal oxide film formation object 10 and trimethylgallium adsorbed to the surface, the wall surfaces of the openings 10A, and the side surfaces of the metal oxide film formation object 10 move to the reaction active region 12A along with movement of the metal oxide film formation object 10 caused by rotation drive of the holding member.

In the reaction active region 12A, the exhaust pressure of the exhaust pipe 50 causes a generated excided and decomposed gas (i.e., hydrogen plasma) of hydrogen and a generated excided and decomposed gas (i.e., oxygen plasma) of oxygen to pass over the wall surfaces of the openings 10A and the side surfaces of the metal oxide film formation object 10 held by the holding member 41 and to be exhausted through the exhaust pipe 50. At this time, trimethylgallium present around the metal oxide film formation object 10, and trimethylgallium adsorbed to the surface, inside, and side surfaces of the metal oxide film formation object 10 are exposed to the excided and decomposed gas (i.e., hydrogen plasma) of hydrogen and the excided and decomposed gas (i.e., oxygen plasma) of oxygen.

Accordingly, trimethylgallium is excited and decomposed by the excited and decomposed gas (i.e., hydrogen plasma) of hydrogen. Excited and decomposed Ga reacts with the excided and decomposed gas (i.e., oxygen plasma) of oxygen to generate a reaction product. The reaction product is deposited on the surface, and the wall surfaces of the opening 10A, and the side surfaces of the metal oxide film formation object 10. As a result, a gallium oxide (GaO) film is formed.

As described above, in the thin-film forming apparatus 101 according to the exemplary embodiment, the exhaust pressure of the exhaust pipe 50 causes the excited and decomposed gas of the film forming gas and the excited and decomposed gas of the non-film-forming gas to reach the wall surfaces of the openings 10A of the metal oxide film formation object 10 and flow over the wall surfaces.

Accordingly, a nearly uniform thin film (i.e., metal oxide film) having an element of the film forming gas as a constituent element, or a nearly uniform thin film (i.e., metal oxide film) having an element of the film forming gas and an element of the non-film-forming gas as constituent elements is also formed on the wall surfaces of the openings 10A of the metal oxide film formation object 10.

### EXAMPLES

Exemplary embodiments will be described below in detail by way of Examples, but the exemplary embodiments are not limited to these Examples. In the following description, the units “part” and “%” are all on a mass basis, unless otherwise specified.

### Production of Metal Oxide Film Formation Object

### Production of Metal Oxide Film Formation Object 1

To a solution obtained by dissolving 40 pars by mass of polyimide (Unitika, Ltd., U-imide KX) in 60 parts by mass of a solvent (N-methylpyrrolidone), 20 parts by mass of resin particles (Nippon Shokubai Co., Ltd., SSX-101) with a mass mean particle size of 1 μm is added and mixed to prepare a coating liquid.

The prepared coating liquid is applied to a SUS sheet so as to obtain a dry film thickness of 100 μm, forming a coating film. The coating film is then dried at 310° C. for 1 hour to form a film.

The film is then peeled off from the SUS sheet and immersed in an organic solvent (toluene) for 6 hours to dissolve and remove resin particles in the film.

A metal oxide film formation object 1 is produced by the above-described method.

### Production of Metal Oxide Film Formation Object 2

A metal oxide film formation object 2 is produced in the same manner as for the production of the metal oxide film formation object 1 except that the resin particles are replaced by 20 parts by mass of resin particles (Nippon Shokubai Co., Ltd., SSX-108) with a mass mean particle size of 8 μm.

### Production of Metal Oxide Film Formation Object 3

A metal oxide film formation object 3 is produced in the same manner as for the production of the metal oxide film formation object 1 except that the resin particles are replaced by 20 parts by mass of resin particles (Nippon Shokubai Co., Ltd., SSX-115) with a mass mean particle size of 15 μm.

### Production of Metal Oxide Film Formation Object 4

To a solution obtained by dissolving 40 pars by mass of polyvinylidene fluoride (Solvay, Solef 6012) in 60 parts by mass of a solvent (dimethylformamide), 20 parts by mass of resin particles (Nippon Shokubai Co., Ltd., SSX-108) with a mass mean particle size of 8 μm is added and mixed to prepare a coating liquid.

The prepared coating liquid is applied to a SUS sheet so as to obtain a dry film thickness of 100 μm, forming a coating film. The coating film is then dried at 230° C. for 1 hour to form a film.

The film is then peeled off from the SUS sheet and immersed in an organic solvent (toluene) for 6 hours to dissolve and remove resin particles in the film.

A metal oxide film formation object 4 is produced by the above-described method.

### Production of Metal Oxide Film Formation Object 5

To a solution obtained by dissolving 30 pars by mass of polystyrene (PS Japan Corporation, SX100) in 70 parts by mass of a solvent (diisopropyl ketone), 20 parts by mass of resin particles (Nippon Shokubai Co., Ltd., SSX-108) with a mass mean particle size of 8 μm is added and mixed to prepare a coating liquid.

The prepared coating liquid is applied to a SUS sheet so as to obtain a dry film thickness of 100 μm, forming a coating film. The coating film is then dried at 280° C. for 1 hour to form a film.

The film is then peeled off from the SUS sheet and immersed in an organic solvent (toluene) for 6 hours to dissolve and remove resin particles in the film.

A metal oxide film formation object 5 is produced by the above-described method.

### Example 1

A metal oxide film made of hydrogen-containing gallium oxide is formed on the metal oxide film formation object 1 in the following manner.

The metal oxide film is formed on the wall surfaces of openings (i.e., the inner wall surfaces of pores) of the metal oxide film formation object 10 by using the thin-film forming apparatus 101 illustrated in FIG. 1 and FIG. 2.

The main settings of the thin-film forming apparatus are as described below.

The reactor 12: a round tubular member 400 mm in inner diameter and 400 mm in tube axial length. The material of the inner wall is stainless steel SUS 304.

The tubular section 42 of the holding member 41: a round tubular stainless steel mesh 82 mm in diameter, 340 mm in axial length, 0.5 mm in mesh size, and 65% in porosity

The size of the discharge surface of the discharge electrode 31: 350 mm long in the longitudinal direction, 50 mm long in the transverse direction

The non-film-forming-gas supply pipe 32: a copper pipe 1 mm in inner diameter

The non-film-forming-gas supply ports 32A: four supply ports are disposed at intervals of 80 mm on the discharge surface of the discharge electrode 31.

The film-forming-gas supply pipe 21: a stainless steel pipe 4 mm in inner diameter

The film-forming-gas supply ports 21A: four supply ports are disposed at intervals of 80 mm.

The positions of the film-forming-gas supply ports 21A: in the reaction inactive region 12B in the reactor 12

The film forming gas-ejection direction: toward the outer surface of the holding member 41

The distance between the discharge surface of the discharge electrode 31 and the outer surface of the holding member 41: 5 mm

The shield members 24A and 24B: plate-shaped member (156 mm×400 mm, 0.5 mm in thickness, material: polyimide)

The minimum distance between the metal oxide film formation object 10 held by the holding member and the shield members 24A and 24B (the distance when the metal oxide film formation object 10 faces the shield members 24A and 24B): 2 mm

The installation of the metal oxide film formation object 10: the metal oxide film formation object 10 is rolled and installed in contact with the outer surface of the holding member 41 (the tubular section 42 thereof) so as to cover the outer surface.

The gas is evacuated from the reactor 12 through the exhaust pipe 50 by using the thin-film forming apparatus 101 having the above-described structure until the inner pressure of the reactor 12 reaches about 0.1 Pa. Next, a He-diluted 40% oxygen gas (flow rate 1.6 sccm) and a hydrogen gas (flow rate 50 sccm) are introduced, as non-film-forming gases, into the reactor 12 from the non-film-forming-gas supply ports 32A of the discharge electrode 31 through the non-film-forming-gas supply pipe 32. At the same time, the conductance valve in the evacuation device 52 is adjusted so that the inner pressure of the reactor 12 becomes 30 Pa. Electric discharge from the discharge electrode 31 is carried out while the output of a 13.56 MHz AC wave from the high-frequency power source 35 is set at 150 W with the matching box 34 and matching is performed with a tuner. The reflected wave at this time is 0 W.

Next, a trimethylgallium gas (flow rate 1.9 sccm) maintained at 20° C. in a thermostatic bath is supplied, as a film forming gas, into the reaction inactive region 12B in the reactor 12 from the film-forming-gas supply ports 21A through the film-forming-gas supply pipe 21. The conductance valve in the evacuation device 52 is adjusted so that the inner pressure of the reactor 12 becomes 5.3 Pa.

In this state, film formation is carried out for 68 minutes while the holding member 41 is rotated at a rotational speed of 500 rpm in the direction denoted by arrow A. At this time, the temperature of the holding member 41 is in the range from 25° C. to about 50° C.

Through the above-described procedure, a porous membrane A having the metal oxide film (i.e., hydrogen-containing gallium oxide) on the inner wall surfaces of pores is obtained.

### Example 2

A metal oxide film made of hydrogen-containing gallium oxide is formed on the metal oxide film formation object 2 by using the same method as that in Example 1.

As a result, a porous membrane B having the metal oxide film (i.e., hydrogen-containing gallium oxide) on the inner wall surfaces of pores is obtained.

### Example 3

A metal oxide film made of hydrogen-containing gallium oxide is formed on the metal oxide film formation object 3 by using the same method as that in Example 1.

As a result, a porous membrane C having the metal oxide film (i.e., hydrogen-containing gallium oxide) on the inner wall surfaces of pores is obtained.

### Example 4

A metal oxide film made of hydrogen-containing gallium oxide is formed on the metal oxide film formation object 2 in the following manner.

Specifically, a porous membrane D having the metal oxide film on the inner wall surfaces of pores is obtained in the same manner as that in Example 1 except that the film formation time in Example 1 is changed from 68 minutes to 34 minutes.

### Example 5

A metal oxide film made of hydrogen-containing gallium oxide is formed on the metal oxide film formation object 2 in the following manner.

Specifically, a porous membrane E having the metal oxide film on the inner wall surfaces of pores is obtained in the same manner as that in Example 1 except that the rotational speed in Example 1 is changed from 500 rpm to 100 rpm.

### Example 6

A metal oxide film made of hydrogen-containing gallium oxide is formed on the metal oxide film formation object 2 in the following manner.

Specifically, a porous membrane F having the metal oxide film on the inner wall surfaces of pores is obtained in the same manner as that in Example 1 except that the film formation time in Example 1 is changed from 68 minutes to 20 minutes.

### Example 7

A metal oxide film made of hydrogen-containing gallium oxide is formed on the metal oxide film formation object 3 in the following manner.

Specifically, a porous membrane G having the metal oxide film on the inner wall surfaces of pores is obtained in the same manner as that in Example 1 except that the film formation time in Example 1 is changed from 68 minutes to 136 minutes.

### Example 8

A metal oxide film made of hydrogen-containing gallium oxide is formed on the metal oxide film formation object 4 by using the same method as that in Example 1.

As a result, a porous membrane H having the metal oxide film (i.e., hydrogen-containing gallium oxide) on the inner wall surfaces of pores is obtained.

### Example 9

A metal oxide film made of hydrogen-containing gallium oxide is formed on the metal oxide film formation object 5 by using the same method as that in Example 1.

As a result, a porous membrane I having the metal oxide film (i.e., hydrogen-containing gallium oxide) on the inner wall surfaces of pores is formed.

### Comparative Example 1

The metal oxide film formation object 2 is used as a porous membrane J without any treatment. In other words, the porous membrane J has no metal oxide film on the inner wall surfaces of pores.

### Measurement and Evaluation

### Various Measurements Using UHR-FE-SEM

The thickness of the porous membrane, the size of pores, the proportion of pores, the mean thickness of the metal oxide film, the degree of thickness uniformity of the metal oxide film are measured for the obtained porous membranes A to I by using the above-described methods.

The thickness of the porous membrane, the size of pores, and the proportion of pores are also measured for the obtained porous membrane J by using the above-described methods.

The results are shown in Table 1.

### Measurement of Physical Properties

The tensile strength at break, the tensile elongation at break, and the permeation flux are measured for the obtained porous membranes A to J by using the above-described methods.

The results are shown in Table 1.

The term “break” in the section of permeation flux in Comparative Example 1 in Table 1 means that the porous membrane breaks immediately (i.e., within 60 seconds) after deionized water permeates the porous membrane.

### Evaluation of Chemical Resistance

The chemical resistance of the obtained porous membranes A to J is evaluated by using the following method.

The obtained porous membranes A to J are each cut out into a size of 50 mm long×20 mm wide to prepare test pieces.

Each of the prepared test pieces is fixed at a bending strain of 1% with a fixture, and a chemical of sodium hypochlorite is applied to the entire surfaces of the test pieces. The test pieces are left to stand at 23° C. for 96 hours and visually checked for whether cracks and fractures are present.

The evaluation criteria are as described below.

—Evaluation Criteria—

G1: There is no crack or fracture.
G2: There is a crack of less than 5 mm.
G3: There is a crack of 5 mm or more.

TABLE 1

| | | | | | | | | | | | Com- |
|---|---|---|---|---|---|---|---|---|---|---|---|
| | | | | | | | | | | | parative |
| | | Exam- | Exam- | Exam- | Exam- | Exam- | Exam- | Exam- | Exam- | Exam- | Exam- |
| | | ple 1 | ple 2 | ple 3 | ple 4 | ple 5 | ple 6 | ple 7 | ple 8 | ple 9 | ple 1 |
| Metal | No. | 1 | 2 | 3 | 2 | 2 | 2 | 3 | 4 | 5 | 2 |
| oxide film | Polymer | poly- | poly- | poly- | poly- | poly- | poly- | poly- | poly- | poly- | poly- |
| formation | compound | imide | imide | imide | imide | imide | imide | imide | vinylidene | styrene | imide |
| object | | | | | | | | | fluoride | | |
| Porous | No. | A | B | C | D | E | F | G | H | I | J |
| membrane | Method for | isolated | isolated | isolated | isolated | isolated | isolated | isolated | isolated | isolated | — |
| | forming | plasma | plasma | plasma | plasma | plasma | plasma | plasma | plasma | plasma | |
| | metal oxide film | CVD | CVD | CVD | CVD | CVD | CVD | CVD | CVD | CVD | |
| | Metal oxide | gallium | gallium | gallium | gallium | gallium | gallium | gallium | gallium | gallium | — |
| | | oxide | oxide | oxide | oxide | oxide | oxide | oxide | oxide | oxide | |
| | Thickness [μm] | 100 | 100 | 100 | 100 | 100 | 100 | 100 | 100 | 100 | 100 |
| | Size of pores | 0.5 | 5 | 10 | 5 | 5 | 5 | 10 | 5 | 5 | 5 |
| | [μm] | | | | | | | | | | |
| | Proportion of | 30 | 40 | 60 | 45 | 40 | 50 | 55 | 40 | 40 | 55 |
| | pores [%] | | | | | | | | | | |
| | Mean thickness | 0.1 | 0.1 | 0.1 | 0.05 | 0.1 | 0.03 | 0.2 | 0.1 | 0.1 | — |
| | of metal oxide | | | | | | | | | | |
| | layer [μm] | | | | | | | | | | |
| | Degree of thick- | 5 | 5 | 5 | 5 | 12 | 5 | 5 | 5 | 5 | — |
| | ness uniformity | | | | | | | | | | |
| | of metal oxide | | | | | | | | | | |
| | layer [%] | | | | | | | | | | |
| | Tensile strength | 12 | 10 | 9 | 8 | 7 | 5 | 12 | 6 | 10 | 4 |
| | at break [MPa] | | | | | | | | | | |
| | Tensile elongation | 120 | 130 | 150 | 160 | 90 | 140 | 60 | 250 | 50 | 150 |
| | at break [%] | | | | | | | | | | |
| | Permeation flux | 0.3 | 0.4 | 0.6 | 0.5 | 0.4 | 0.5 | 0.6 | 0.4 | 0.4 | break |
| | [L/(m² · h)] | | | | | | | | | | |
| | Chemical | G1 | G1 | G1 | G1 | G1 | G2 | G1 | G1 | G2 | G3 |
| | resistance | | | | | | | | | | |

The above-described results indicate that the porous membranes in Examples have a higher tensile strength at break than that in Comparative Example and thus have higher mechanical strength.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A porous membrane comprising:
a porous membrane base containing a polymer compound and having pores interconnected in a thickness direction; and
a metal oxide film on inner wall surfaces of the pores.

2. The porous membrane according to claim 1, wherein the pores have a size of 0.1 μm or more and 50 μm or less.

3. The porous membrane according to claim 2, wherein the pores have a size of 0.5 μm or more and 10 μm or less.

4. The porous membrane according to claim 1, wherein the metal oxide film has a mean thickness of 0.01 μm or more and 0.2 μm or less.

5. The porous membrane according to claim 1, wherein the pores have a size of 0.5 μm or more and 10 μm or less, and the metal oxide film has a mean thickness of 0.01 μm or more and 0.2 μm or less.

6. The porous membrane according to claim 1, wherein a degree of thickness uniformity obtained from the following formula (1) is 20% or less,
Degree of thickness uniformity=(X−Y)/(X+Y)×100 Formula (1):
where X represents a maximum thickness of the metal oxide film and Y represents a minimum thickness of the metal oxide film.

7. The porous membrane according to claim 1, wherein the metal oxide film contains an oxide of a group 13 element.

8. The porous membrane according to claim 6, wherein the metal oxide film contains gallium oxide.

9. The porous membrane according to claim 1, wherein the porous membrane has a mean thickness of 50 μm or more and 500 μm or less.

10. The porous membrane according to claim 1, wherein the porous membrane has a tensile strength at break of 5 MPa or more.

11. The porous membrane according to claim 1, wherein the porous membrane has a tensile elongation at break of 50% or more.

12. The porous membrane according to claim 1, wherein a permeation flux of water pressurized at a pressure of 20 kPa through the porous membrane is 0.2 L/(m²·h) or more.

13. The porous membrane according to claim 1, wherein the porous membrane is a water treatment membrane or a dialysis membrane.

14. A method for producing a porous membrane having a metal oxide film on inner wall surfaces of pores, the method comprising:
supplying a film forming gas to a reaction inactive region of a reactor that includes, in an inside thereof, a porous membrane including a porous membrane base containing a polymer compound and having pores interconnected in a thickness direction, is designed to use excitation and decomposition of the film forming gas supplied to the inside so as to deposit a film having an element of the film forming gas as a constituent element, and has a reaction active region where the film-forming gas is capable of being excited and decomposed and the reaction inactive region continuous with the reaction active region;
exciting and decomposing the film forming gas in the reactor;
repeatedly moving the porous membrane between the reaction inactive region and the reaction active region by driving a holding member while the porous membrane is held by the holding member, wherein the film forming gas is supplied to the reaction active region from the reaction inactive region along with movement of the porous membrane; and
exhausting gas from the reactor through an exhaust pipe in the reactor, the gas having passed through the pores of the porous membrane base of the porous membrane held by the holding member.
